(19) United States
(12) Patent Application Publication
(10) Pub. No.: US 2023/0296385 A1
(43) Pub. Date: Sep. 21, 2023

(54) INFORMATION PROCESSING METHOD, INFORMATION PROCESSING DEVICE, AND PROGRAM

(71) Applicant: MITSUBISHI HEAVY INDUSTRIES, LTD., Tokyo (JP)

(72) Inventors: Kenji TAKAO, Tokyo (JP); Atsuyoshi SAIMEN, Tokyo (JP)

(73) Assignee: MITSUBISHI HEAVY INDUSTRIES, LTD., Tokyo (JP)

(21) Appl. No.: 18/117,648

(22) Filed: Mar. 6, 2023

(30) Foreign Application Priority Data
Mar. 16, 2022 (JP) 2022-041725

(51) Int. Cl. G01C 21/20; G05D 1/02

(52) U.S. Cl. CPC G01C 21/206; G05D 1/0214; G05D 2201/0216

(57) ABSTRACT

An information processing method includes acquiring obstacle information from a mobile body moving along a route to a target position, the obstacle information indicating that an obstacle is present on the route, and setting an updated route leading to an updated position as a route for the mobile body upon receipt of the obstacle information, the updated position being a position different from the target position.

### CROSS-REFERENCE TO RELATED APPLICATIONS

This application claims the benefit of priority to Japanese Patent Application Number 2022-041725 filed on Mar. 16, 2022. The entire contents of the above-identified application are hereby incorporated by reference.

### TECHNICAL FIELD

The disclosure relates to an information processing method, an information processing device, and a program.

### RELATED ART

There is a known technology for setting travel routes for a plurality of mobile bodies that move automatically. For example, JP 6599139 B describes an operation management method in which a basic travel route that is a shortest distance from a current position of a cargo handling vehicle to a start position of a work is set, and when the basic travel route interferes with a basic travel route of another cargo handling vehicle, the basic travel route of the vehicle having a higher priority is adopted and a detour route is set for the vehicle having a lower priority.

### SUMMARY

However, in the case where an obstacle is located on a route of a mobile body, and, for example, if it is impossible to generate another route that leads to a target position while avoiding the obstacle, the mobile body is kept stopped in front of the obstacle. In this case, the work cannot be continued, and thus an operating ratio is reduced. Therefore, there is a need for suppressing a reduction in the operating ratio of the mobile body.

The disclosure has been made to solve the above-described problem, and an object of the disclosure is to provide an information processing method, an information processing device, and a program that can suppress the reduction in the operating ratio of a mobile body.

An information processing method according to the disclosure includes acquiring obstacle information from a mobile body moving along a route to a target position, the obstacle information indicating that an obstacle is present on the route, and setting an updated route leading to an updated position as a route for the mobile body upon receipt of the obstacle information, the updated position being a position different from the target position.

An information processing method according to the disclosure includes acquiring obstacle information from a mobile body moving along a route to a first target position, the obstacle information indicating that an obstacle is present on the route, and setting a detection route for a mobile body for which a route to a second target position different from the first target position has been set upon acquisition of the obstacle information, the detection route being a route passing through a detection position at which the obstacle can be detected and reaching the second target position.

An information processing device according to the disclosure includes an obstacle information acquisition unit configured to acquire obstacle information through a mobile body moving along a route to a target position, the obstacle information indicating that an obstacle is present on the route, and a work setting unit configured to set an updated route to an updated position as a route for the mobile body upon receipt of the obstacle information, the updated position being a position different from the target position.

A program according to the disclosure causes a computer to perform processing, the processing including acquiring obstacle information through a mobile body moving along a route to a target position, the obstacle information indicating that an obstacle is present on the route, and setting an updated route to an updated position as a route for the mobile body upon receipt of the obstacle information, the updated position being a position different from the target position.

According to the disclosure, the reduction in the operating ratio of a mobile body can be suppressed.

### BRIEF DESCRIPTION OF DRAWINGS

The disclosure will be described with reference to the accompanying drawings, wherein like numbers reference like elements.

FIG. 1 is a schematic view of a movement control system according to the present embodiment.

FIG. 2 is a schematic view of a configuration of a mobile body.

FIG. 3 is a schematic block diagram of a management device.

FIG. 4 is a schematic block diagram of an information processing device.

FIG. 5 is a schematic block diagram of a control device for the mobile body.

FIG. 6 is a table showing an example of movement destination information.

FIG. 7 is a table for explaining the setting of a work.

FIG. 8 is a schematic view illustrating processing to be performed when an obstacle is present.

FIG. 9 is a schematic view illustrating an example of dropping a target object at an updated position.

FIG. 10 is a schematic view illustrating an example of dropping a target object at a current position.

FIG. 11 is a flowchart illustrating a flow for setting an updated route.

FIG. 12 is a schematic view illustrating an example of setting a detection route.

FIG. 13 is a schematic view illustrating an example of setting a detection route.

### DESCRIPTION OF EMBODIMENTS

Hereinafter, preferred embodiments of the disclosure will be described in detail with reference to the accompanying drawings. Note that the disclosure is not limited to these embodiments, and when there are a plurality of embodiments, the disclosure is intended to include a configuration combining these embodiments.

### First Embodiment

### Movement Control System

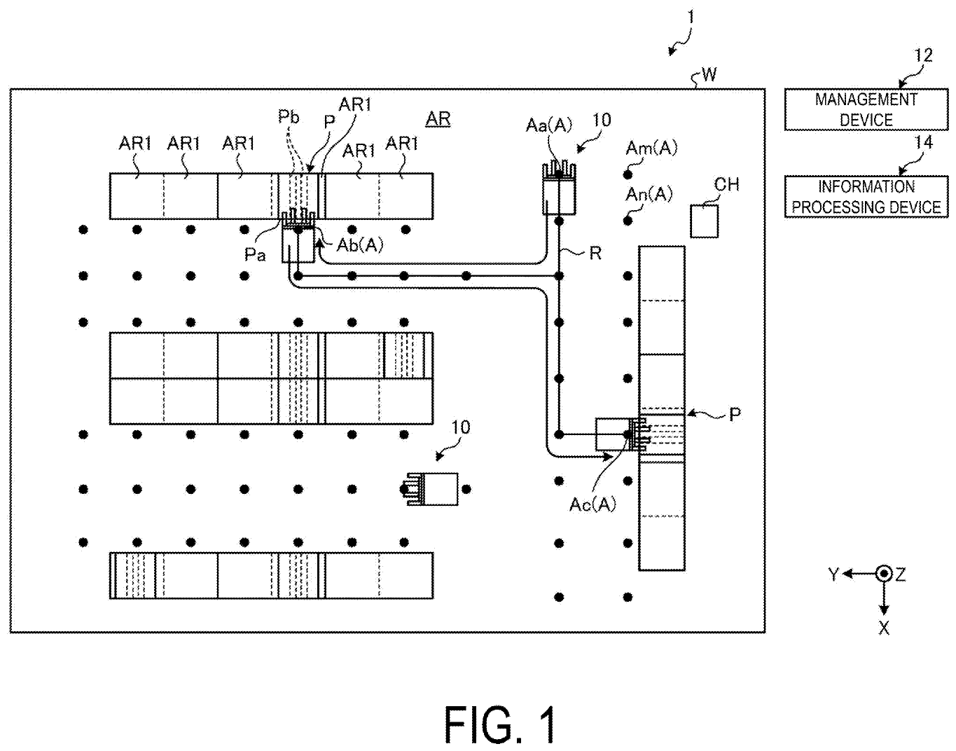

FIG. 1 is a schematic view of a movement control system according to the present embodiment. As illustrated in FIG. 1, a movement control system 1 according to the present embodiment includes a mobile body 10, a management device 12, and an information processing device 14. The movement control system 1 is a system that controls the movement of the mobile body 10 belonging to a facility W. The facility W is a facility, such as a warehouse, that is logistically managed. The movement control system 1 causes the mobile body 10 to pick up and convey a target object P disposed within an area AR in the facility W. The area AR is, for example, a floor surface of the facility W, and is an area in which the target object P is placed and through which the mobile body 10 moves. In the present embodiment, the target object P is a conveyance target object composed of a pallet and a burden loaded on the pallet. The target object P includes an opening Pb into which a fork 24 of the mobile body 10 to be described later is inserted, and the opening Pb is formed in a front surface Pa of the target object P. However, the target object P is not limited to an object composed of a pallet and a burden loaded on the pallet, and may be only a burden without a pallet, for example.

Hereinafter, an operation including movement along a route R (to be described later) by the mobile body 10 will be appropriately referred to as a work of the mobile body 10. Further, in the present embodiment, the mobile body 10 moves along the route R to load, convey, and unload the target object P, and thus a series of operations by the mobile body 10 to move along the route R, and load, convey, and unload the target object P can be said to be the work of the mobile body 10. Hereinafter, one direction along the area AR is referred to as an X direction, and a direction along the area AR that is orthogonal to the X direction is referred to as a Y direction. In the present embodiment, the Y direction is a direction orthogonal to the X direction. The X direction and the Y direction may be horizontal directions. A direction orthogonal to the X direction and the Y direction, more specifically, an upward direction in the vertical direction is referred to as a Z direction. In the present embodiment, unless otherwise specified, a “position” refers to a position (coordinates) in a coordinate system in a two dimensional plane on the area AR (the coordinate system of the area AR). Also, unless otherwise specified, an “orientation” of the mobile body 10 or the like refers to an orientation of the mobile body 10 in the coordinate system of the area AR, and means a yaw angle (rotation angle) of the mobile body 10 with the X direction defined as 0 degrees when viewed from the Z direction.

A plurality of placement areas AR1 is disposed in the area AR in the facility W. The placement areas AR1 are configured to be used as areas in which the target object P is placed. The target object P may be placed or may not be placed in each placement area AR1 depending on the situation of the facility W. The position (coordinates), the shape, and the size of the placement area AR1 are determined in advance. In the example illustrated in FIG. 1, the placement areas AR1 are set on a shelf provided in the area AR, but are not limited thereto, and may be provided on the area AR (i.e., on the floor of the facility W), or may be provided in a loading platform of a vehicle that has conveyed the target object P into the facility W. In addition, in the present embodiment, the placement area AR1 is defined for each target object P, and one target object P is placed in each placement area AR1, but the disclosure is not limited thereto. For example, the placement area AR1 may be set as a free space in which a plurality of target objects P are placed. In addition, in the example in FIG. 1, the placement area AR1 has a rectangular shape, but may have any shape and any size, and the number of the placement areas AR1 is also optional.

### Waypoint

In the area AR, a waypoint A is set for each position (coordinates). The route R along which the mobile body 10 moves is configured to connect the waypoints A. That is, a route connecting the waypoints A through which the mobile body 10 is scheduled to pass is the route R of the mobile body 10. The waypoints A are set according to the layout of the facility W such as the positions of the placement areas AR1 and passages. For example, the waypoints A are set in a matrix form in the area AR, and the positions and the number of the waypoints A are set such that a route R connecting a position facing one placement area AR1 to a position facing another arbitrary placement area AR1 can be set. The position facing the placement area AR1 may be, for example, a position at which the mobile body 10 can pick up the target object P placed in the placement area AR1. In addition, the waypoints A include a waypoint A configured to be a charging point (in the example of FIG. 1, a waypoint An at which a charger CH is placed) or a waypoint A configured to be a waiting point (in the example of FIG. 1, a waypoint Am). The waypoint A that is a charging point or a waiting point may be set at any position that does not overlap with a route (the route used for conveyance) connecting the waypoints A facing the respective placement areas AR1.

### Mobile Body

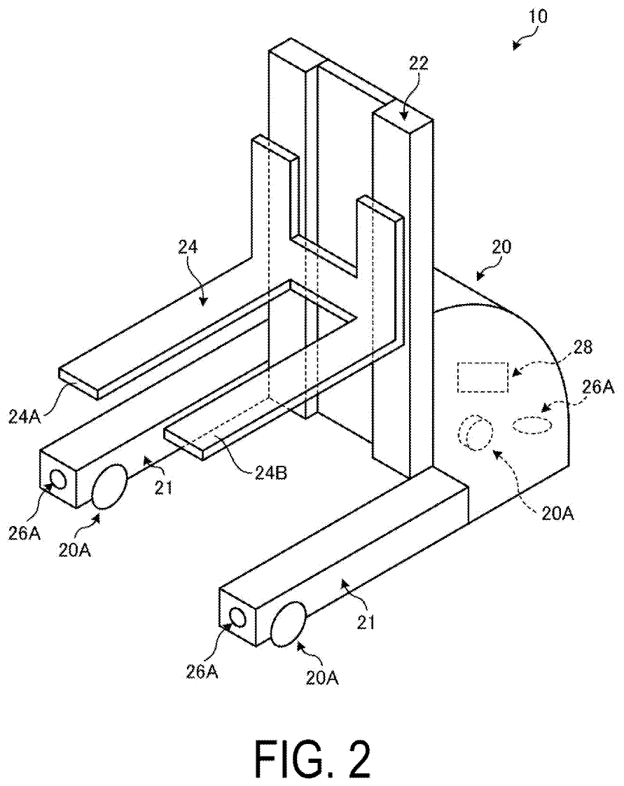

FIG. 2 is a schematic view of a configuration of a mobile body. The mobile body 10 is a device that can move automatically and convey the target object P. Further, in the present embodiment, the mobile body 10 is a forklift, and more specifically, a so-called automated guided vehicle (AGV) or a so-called automated guided forklift (AGF). However, the mobile body 10 is not limited to a forklift for conveying the target object P, and may be any device capable of moving automatically.

As illustrated in FIG. 2, the mobile body 10 includes a vehicle body 20, a wheel 20A, a straddle leg 21, a mast 22, a fork 24, a sensor 26A, and a control device 28. The straddle leg 21 is a shaft-like member that is disposed in pairs at one end portion of the vehicle body 20 in a front-back direction and protrudes from the vehicle body 20. The wheel 20A is disposed at a leading end of each of the straddle legs 21 and at the vehicle body 20. That is, a total of three wheels 20A are disposed, but the positions and the number of the wheels 20A disposed may be arbitrary. The mast 22 is movably attached to the straddle legs 21 and moves in the front-back direction of the vehicle body 20. The mast 22 extends along the vertical direction (here, the direction Z) orthogonal to the front-back direction. The fork 24 is attached to the mast 22 so as to be movable in the direction Z. The fork 24 may be movable in a lateral direction of the vehicle body 20 (a direction intersecting with the vertical direction and the front-back direction) with respect to the mast 22. The fork 24 includes a pair of tines 24A and 24B. The tines 24A and 24B extend, from the mast 22, toward the front direction of the vehicle body 20. The tines 24A and 24B are arranged separated from each other in the lateral direction of the mast 22. In the front-back direction, a direction to a side of the mobile body 10 where the fork 24 is disposed and a direction to a side where the fork 24 is not disposed are referred to as a front direction and a back direction, respectively.

The sensors 26A detect at least one of the position and the orientation of a target object present in the periphery of the vehicle body 20. That is, it can be said that the sensor 26A detects at least one of the position of the target object relative to the mobile body 10 and the orientation of the target object relative to the mobile body 10. In the present embodiment, the sensor 26A is disposed at a leading end of each of the straddle legs 21 in the front direction, and at the vehicle body 20 on a back direction side. However, the positions at which the sensors 26A are disposed are not limited thereto, and the sensors 26A may be disposed at any positions, and the number of the sensors 26A disposed may be arbitrary.

The sensor 26A is a sensor that emits a laser beam, for example. The sensor 26A emits the laser beam while performing scanning in one direction (here, the lateral direction), and detects the position and the orientation of the target object based on the reflected light of the laser beam emitted. That is, the sensor 26A is a so-called two-dimensional (2D) light detection and ranging (LiDAR) sensor. Note that the sensor 26A is not limited to the one described above and may be a sensor that detects the target object using any method, such as a so-called three-dimensional (3D)-LiDAR in which scanning is performed in multiple directions, or may be a so-called one dimensional (1D)-LiDAR in which no scanning is performed, or may be a camera.

The control device 28 controls the movement of the mobile body 10. The control device 28 will be described later.

### Management Device

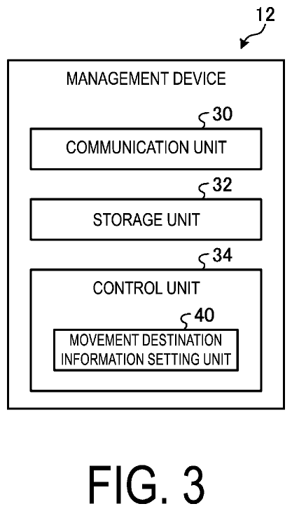

FIG. 3 is a schematic block diagram of a management device. The management device 12 is a system that manages physical distribution in the facility W. The management device 12 is a warehouse control system (WCS) or a warehouse management system (WMS) in the present embodiment, but is not limited to a WCS and a WMS, and may be any system including a backend system such as any other production management system. The management device 12 may be disposed at any position, and may be disposed in the facility W, or may be disposed at a separate position from the facility W so as to manage the facility W from the separate position. The management device 12 is a computer and includes a communication unit 30, a storage unit 32, and a control unit 34 as illustrated in FIG. 3.

The communication unit 30 is a module used by the control unit 34 to communicate with an external device such as the information processing device 14, and may include, for example, a Wi-Fi (registered trademark) module or an antenna. The communication method of the communication unit 30 is wireless communication in the present embodiment, but any communication method may be used. The storage unit 32 is a memory that stores various information such as computation contents of the control unit 34 and programs, and includes, for example, at least one of a primary storage device such as a random access memory (RAM) or a read only memory (ROM), and an external storage device such as a hard disk drive (HDD).

The control unit 34 is an arithmetic device and includes, for example, an arithmetic circuit such as a central processing unit (CPU). The control unit 34 includes a movement destination information setting unit 40. The control unit 34 reads a program (software) from the storage unit 32 and executes the program to implement the movement destination information setting unit 40 and perform the processing thereof. Note that the control unit 34 may execute such processing with a single CPU, or may include a plurality of CPUs and execute the processing with the plurality of CPUs. The movement destination information setting unit 40 may be implemented by a hardware circuit. The program for the control unit 34 stored in the storage unit 32 may be stored in a recording medium that is readable by the management device 12.

The movement destination information setting unit 40 sets movement destination information indicating a movement destination of the mobile body 10. The processing by the movement destination information setting unit 40 will be more specifically described later.

Note that the management device 12 may execute processing other than the setting of the movement destination information. For example, the management device 12 may also set information for controlling a mechanism other than the mobile body 10 disposed in the facility W (for example, an elevator and a door).

### Information Processing Device

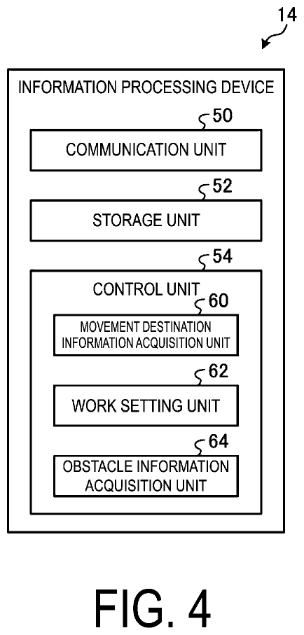

FIG. 4 is a schematic block diagram of the information processing device. The information processing device 14 is a device that is disposed in the facility W and processes information related to the movement of the mobile body 10. The information processing device 14 is, for example, a fleet control system (FCS), but is not limited thereto, and may be any device that processes information related to the movement of the mobile body 10. The information processing device 14 is a computer and includes a communication unit 50, a storage unit 52, and a control unit 54 as illustrated in FIG. 4. The communication unit 50 is a module used by the control unit 54 to communicate with an external device such as the management device 12 and the mobile body 10, and may include, for example, an antenna or a WiFi module. The communication method of the communication unit 50 is wireless communication in the present embodiment, but any communication method may be used. The storage unit 52 is a memory for storing various information such as computation contents of the control unit 54 and programs, and includes, for example, at least one of a primary storage device such as a RAM or a ROM, and an external storage device such as an HDD.

### Information Processing Device

FIG. 4 is a schematic block diagram of the information processing device. The information processing device 14 is a device that is disposed in the facility W and processes information related to the movement of the mobile body 10. The information processing device 14 is, for example, a fleet control system (FCS), but is not limited thereto, and may be any device that processes information related to the movement of the mobile body 10. The information processing device 14 is a computer and includes a communication unit 50, a storage unit 52, and a control unit 54 as illustrated in FIG. 4. The communication unit 50 is a module used by the control unit 54 to communicate with an external device such as the management device 12 and the mobile body 10, and may include, for example, an antenna or a WiFi module. The communication method of the communication unit 50 is wireless communication in the present embodiment, but any communication method may be used. The storage unit 52 is a memory for storing various information such as computation contents of the control unit 54 and programs, and includes, for example, at least one of a primary storage device such as a RAM or a ROM, and an external storage device such as an HDD.

The control unit 54 is an arithmetic device and includes an arithmetic circuit such as a CPU, for example. The control unit 54 includes a movement destination information acquisition unit 60, a work setting unit 62, and an obstacle information acquisition unit 64. The control unit 54 reads a program (software) from the storage unit 52 and executes the program to implement the movement destination information acquisition unit 60, the work setting unit 62, and the obstacle information acquisition unit 64 and perform the processing thereof. Note that the control unit 54 may execute such processing with a single CPU or may include a plurality of CPUs and execute the processing with the plurality of CPUs. At least a part of the movement destination information acquisition unit 60, the work setting unit 62, and the obstacle information acquisition unit 64 may be implemented by a hardware circuit. The program for the control unit 54 stored in the storage unit 52 may be stored in a recording medium that is readable by the information processing device 14.

The movement destination information acquisition unit 60 acquires the movement destination information, the work setting unit 62 sets the route R of the mobile body 10, and the obstacle information acquisition unit 64 acquires obstacle information indicating that an obstacle is present on the route R of the mobile body 10. Specific contents of the above-described processing will be described later.

Note that, in the present embodiment, the management device 12 and the information processing device 14 are separate devices, but may be an integrated device. That is, the management device 12 may have at least a part of the function of the information processing device 14, and the information processing device 14 may have at least a part of the function of the management device 12.

### Control Device for Mobile Body

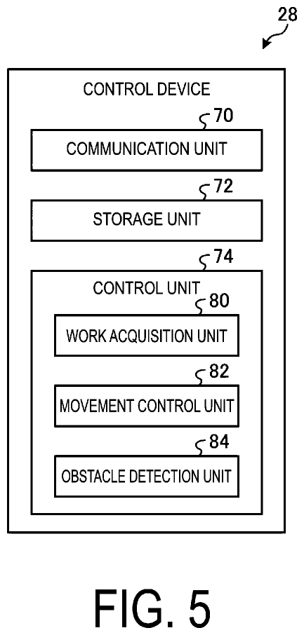

Next, the control device 28 for the mobile body 10 will be described. FIG. 5 is a schematic block diagram of a control device for the mobile body. The control device 28 is a device for controlling the mobile body 10. The control device 28 is a computer and includes a communication unit 70, a storage unit 72, and a control unit 74 as illustrated in FIG. 5. The communication unit 70 is a module used by the control unit 74 to communicate with an external device such as the information processing device 14, and may include, for example, an antenna or a WiFi (registered trademark) module. The communication method of the communication unit 70 is wireless communication in the present embodiment, but any communication method may be used. The storage unit 72 is a memory for storing various information such as computation contents of the control unit 74 and programs, and includes, for example, at least one of a primary storage device such as a RAM or a ROM, and an external storage device such as an HDD.

The control unit 74 is an arithmetic device and includes an arithmetic circuit such as a CPU, for example. The control unit 74 includes a work acquisition unit 80, a movement control unit 82, and an obstacle detection unit 84. The control unit 74 reads a program (software) from the storage unit 72 and executes the program to implement the work acquisition unit 80, the movement control unit 82, and the obstacle detection unit 84 and perform the processing thereof. Note that the control unit 74 may execute such processing with a single CPU or may include a plurality of CPUs and execute the processing with the plurality of CPUs. At least a part of the work acquisition unit 80, the movement control unit 82, and the obstacle detection unit 84 may be implemented by a hardware circuit. In addition, the program for the control unit 74 stored in the storage unit 72 may be stored in a recording medium that is readable by the control device 28.

The work acquisition unit 80 acquires information indicating the route R of the mobile body 10, the movement control unit 82 controls a movement mechanism such as a drive unit or a steering device of the mobile body 10 so as to control the movement of the mobile body 10. The obstacle detection unit 84 detects an obstacle located on the route R of the mobile body 10. Specific contents of the above-described processing will be described later.

### Processing of Movement Control System

Next, the processing contents of the movement control system 1 will be described.

### Setting of Movement Destination Information

The movement destination information setting unit 40 of the management device 12 sets movement destination information indicating a movement destination of the mobile body 10. The movement destination information includes information indicating the position of the movement destination of the mobile body 10. More specifically, in the present embodiment, the movement destination information setting unit 40 sets the movement destination information so as to include first position information (position information of a first position) and second position information (position information of a second position). The first position is a position which the mobile body 10 reaches first, and the second position is a position which the mobile body 10 reaches next to the first position. That is, in the example of the present embodiment, the first position is the position of a conveyance source of the target object P, and the second position is the position of a conveyance destination of the target object P. The movement destination information setting unit 40 may directly specify the position (coordinates) of the first position as the first position information. In addition, an identifier may be assigned to each waypoint A, and the movement destination information setting unit 40 may specify the identifier of a waypoint A corresponding to the first position as the first position information. The same applies to the second position information.

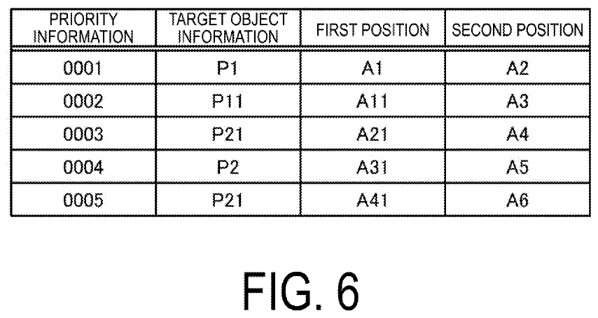

FIG. 6 is a table showing an example of movement destination information. In the present embodiment, the movement destination information setting unit 40 sets the movement destination information for each target object P to be conveyed, in other words, for each work. That is, the movement destination information setting unit 40 associates target object information indicating a target object P to be conveyed, the first position information that is the conveyance source of the target object P, and the second position information indicating the conveyance destination of the target object P with each other so as to set the movement destination information for each target object P. Note that, for example, an identifier may be assigned to each target object P, and information indicating the identifier may be used as the target object information. Further, as illustrated in FIG. 6, in the present embodiment, it is preferable for the movement destination information setting unit 40 to associate the target object information, the first position information, the second position information, and priority information with each other so as to set the movement destination information for each target object P. The priority information is information indicating a priority order for conveying a target object P among a group of movement destination information for each target object P. That is, for example, a target object P having the highest priority in the priority information is to be conveyed first. FIG. 6 shows an example in which pieces of movement destination information are set as follows: movement destination information in which the priority is 0001 (first), the target object is P1, the first position is A1, and the second position is A2; movement destination information in which the priority is 0002 (second), the target object is P11, the first position is A11, and the second position is A3; movement destination information in which the priority is 0003 (third), the target object is P21, the first position is A21, and the second position is A4; movement destination information in which the priority is 0004 (fourth), the target object is P2, the first position is A31, and the second position is A5; and movement destination information in which the priority is 0005 (fifth), the target object is P21, the first position is A41, and the second position is A6. However, FIG. 6 is only an example, and the movement destination information may be arbitrarily set in accordance with an order status or the like.

In addition, the movement destination information setting unit 40 may set the movement destination information so as to include designation information for designating a mobile body 10 to move from the first position to the second position (a mobile body 10 to perform the work). That is, in the example of the present embodiment, the movement destination information setting unit 40 may associate the target object information, the first position information, the second position information, the priority information, and the designation information with each other so as to set the movement destination information for each target object P. In that case, for example, an identifier may be assigned to each mobile body 10, and information indicating the identifier may be used as the designation information.

The movement destination information setting unit 40 may set the movement destination information in any method. For example, the movement destination information setting unit 40 may acquire an order information indicating a target object P to be conveyed, a conveyance source, and a conveyance destination, and set the movement destination information based on the order information. The movement destination information setting unit 40 transmits the set movement destination information to the information processing device 14 via the communication unit 30.

### Acquisition of Movement Destination Information

The movement destination information acquisition unit 60 of the information processing device 14 acquires the movement destination information from the management device 12 via the communication unit 50.

### Setting of Work

The work setting unit 62 of the information processing device 14 sets a work of the mobile body 10 based on the movement destination information. The work setting unit 62 sets the route R of the mobile body 10 to the movement destination as the work of the mobile body 10. In the present embodiment, the work setting unit 62 sets, as the route R of the mobile body 10, a first route to the first position (conveyance source) indicated by the first position information from an initial position at which the mobile body 10 is located immediately before starting to move to the first position, and a second route to the second position (conveyance destination) indicated by the second position information from the first position. That is, the work setting unit 62 sets the route R of the mobile body 10 such that respective waypoints A from the initial position to the first position are set as the first route, and respective waypoints A from the first position to the second position are set as the second route. In the example of FIG. 1, the movement destination information indicates that the first position is a waypoint Ab and the second position is a waypoint Ac, and the work setting unit 62 sets, as the route R of the mobile body 10, the first route passing through respective waypoints A from the waypoint Aa, which is the initial position of the mobile body 10 selected, to the waypoint Ab, and the second route passing through respective waypoints A from the waypoint Ab to the waypoint Ac.

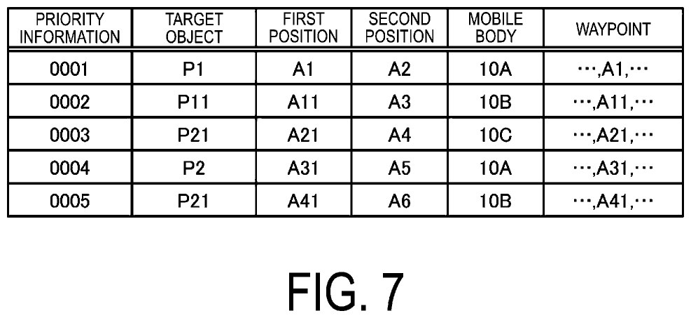

FIG. 7 is a table for explaining the setting of the work. When a plurality of mobile bodies 10 are deployed in the facility W, the work setting unit 62 selects a mobile body 10 that conveys a target object P as the work of the mobile body 10. Also, when the movement destination information is set for a plurality of target objects P, the work setting unit 62 sets the route R of a mobile body 10 for each target object P. That is, the work setting unit 62 selects, for each target object P, a mobile body 10 that conveys the target object P, and sets the route of the selected mobile body 10. In the example of FIG. 7, the work setting unit 62 selects a mobile body 10A as the mobile body 10 that conveys a target object P1 indicated by the movement destination information, and sets a route from the initial position of the mobile body 10A, through A1 as the first position, to A2 as the second position ( . . . waypoint A1 . . . ). Descriptions of mobile bodies selected for other target objects P illustrated in FIG. 7 and the routes (waypoints) thereof are the same as those above, and thus are omitted. Note that the work setting unit 62 may select a mobile body 10 in any manner, and may select a mobile body 10 for each target object P such that the time until the completion of the conveyance of all the target objects P is the shortest, for example. In the case where a target mobile body 10 has been designated as the designation information in the movement destination information, it is only necessary to select the mobile body 10 designated in the designation information.

The work setting unit 62 also sets a reserved time period during which the selected mobile body 10 passes through the route R (waypoints A) as the work of the mobile body 10. In this case, other mobile bodies 10 are prohibited from passing through the route R during the reserved time period. That is, the selected mobile body 10 occupies the set route R during the reserved time period. In setting the route R for each of a plurality of target objects P, the work setting unit 62 sets a mobile body 10, a route R (waypoints A), and a reserved time period for each target object P such that, in the reserved time period of one mobile body 10, the same waypoints A as those for the one mobile body 10 are not set for other mobile bodies (such that there is no overlapping of reserved time periods) and such that no deadlock occurs even when there is no overlapping of reserved time periods. Further, the work setting unit 62 may set a route R and a reserved time period also based on the priority information in the movement destination information. That is, the work setting unit 62 sets a mobile body 10, a route R, and a reserved time period for each target object P such that there is no overlapping of reserved time periods and that the conveyance of a target object P having a higher priority is completed sooner. Note that the route R includes a plurality of waypoints A, and thus the work setting unit 62 may set a reserved time period for each waypoint A included in the route R.

Note that the deadlock refers to a phenomenon in which each of a plurality of running programs or the like mutually waits for a result of other programs, and remains in a standby state and does not operate. In the present embodiment, the deadlock may refer to a phenomenon in which the mobile bodies 10 remain stopped if there is a possibility that the mobile bodies 10 will collide with each other when the mobile bodies 10 keep moving along the current routes, and if it is impossible to set avoidance routes toward travel direction sides.

The work setting unit 62 transmits information on the set work to the mobile body 10 to which the set work is assigned. In the example of FIG. 7, the work setting unit 62 transmits information on the work for the target object P1 and information on the work for the target object P2 to the mobile body 10A. The work setting unit 62 transmits information on the route R as the information on the work. The work setting unit 62 transmits information indicating respective waypoints A through which the route R passes as the information on the route R. For example, the work setting unit 62 may transmit position (coordinate) information of respective waypoints A through which the route R passes to the mobile body 10 as the information on the route R, or may transmit information indicating the identifiers of respective waypoints A through which the route R passes to the mobile body 10 as the information on the route R. Further, in the present embodiment, the work setting unit 62 also transmits information on the reserved time period, that is, information indicating the reserved time period during which the mobile body 10 passes through the route (waypoints A) to the mobile body 10 as the information on the work.

### Movement of Mobile Body

The work acquisition unit 80 of a mobile body 10 acquires information on the route R set for the mobile body 10 from the information processing device 14. The movement control unit 82 of the mobile body 10 moves the mobile body 10 along the route R acquired. In the present embodiment, the work acquisition unit 80 also acquires information on the reserved time period together with the information on the route R. The movement control unit 82 causes the mobile body 10 to pass through each waypoint A through which the route R passes during the reserved time period set for each waypoint A. The mobile body 10 moves so as to pass through each waypoint A on the route R by sequentially grasping the position information of the mobile body 10 through the movement control unit 82. The method of acquiring the position information of the mobile body 10 through the movement control unit 82 is arbitrary. In the present embodiment, for example, a detection body (not illustrated) is disposed in the facility W, and the movement control unit 82 acquires the information on the position and the orientation of the mobile body 10 based on the detection of the detection body. Specifically, the mobile body 10 irradiates the detection body with a laser beam, receives light of the laser beam reflected from the detection body, and detects the position and the orientation of the mobile body 10 in the facility W. The method of acquiring the information on the position and the orientation of the mobile body 10 is not limited to using a detection body, and simultaneous localization and mapping (SLAM) may be used, for example.

In the example of FIG. 1, the movement control unit 82 causes the mobile body 10 to move from the waypoint Aa, which is the initial position, to the waypoint Ab, which is the first position, so as to pass through each waypoint A from the waypoint Aa to the waypoint Ab. When the mobile body 10 reaches the waypoint Ab, the movement control unit 82 controls the fork 24 to insert the fork 24 into the opening Pb of the target object P placed in the placement area AR1 facing the waypoint Ab so as to pick up (load) the target object P. In this case, the movement control unit 82 may cause the sensor 26A to detect the position and the orientation of the target object P at the waypoint Ab or at any position before reaching the waypoint Ab. Then, the movement control unit 82 may set an approach route to the target object P based on the position and the orientation of the target object P, and approach the target object P along the approach route to pick up the target object P. That is, in that case, the movement control unit 82 may set a new approach route that allows a predetermined position and a predetermined orientation with respect to the position and the orientation of the target object P detected (the position and the orientation at which the mobile body 10 can pick up the target object P), and approach the target object P along the approach route. Alternatively, for example, the movement control unit 82 may cause the mobile body 10 to approach the target object P by performing feedback control (direct feedback control) based on the detection result of the position and the orientation of the target object P and the detection result of the position and the orientation of the mobile body 10. In that case, switching to the direct feedback control may be performed during the approach along a route based on the position and the orientation of the target object P.

After the mobile body 10 picks up the target object P, the movement control unit 82 causes the mobile body 10 to return to the waypoint Ab and then move to the waypoint Ac, which is the second position, so as to pass through each waypoint A from the waypoint Ab to the waypoint Ac. When the mobile body 10 reaches the waypoint Ac, the movement control unit 82 controls the fork 24 to drop (unload) the target object P in the placement area AR1 facing the waypoint Ac.

After the mobile body 10 drops the target object P, the movement control unit 82 causes the mobile body 10 to return to the waypoint Ac. When a next route R in which the waypoint Ac is the initial position has already been set, the movement control unit 82 causes the mobile body 10 to move along that route R.

### Obstacle

Here, there may be a case where an obstacle is present on the route R along which the mobile body 10 is moving. For example, if it is impossible to generate a route that leads to a target position while avoiding the obstacle, the mobile body 10 remains stopped in front of the obstacle and cannot continue the work, and consequently the operating ratio of the mobile body 10 is reduced. In contrast, in the present embodiment, when an obstacle is located on the route R, an updated route to an updated position that is different from the target position of the route R is set, and the mobile body 10 moves along the updated route. Accordingly, the work of the mobile body 10 can be continued, and the reduction in the operating ratio can be suppressed. Note that the obstacle here may be any object including, for example, another mobile body 10 that is stopped.

### Detection of Obstacle

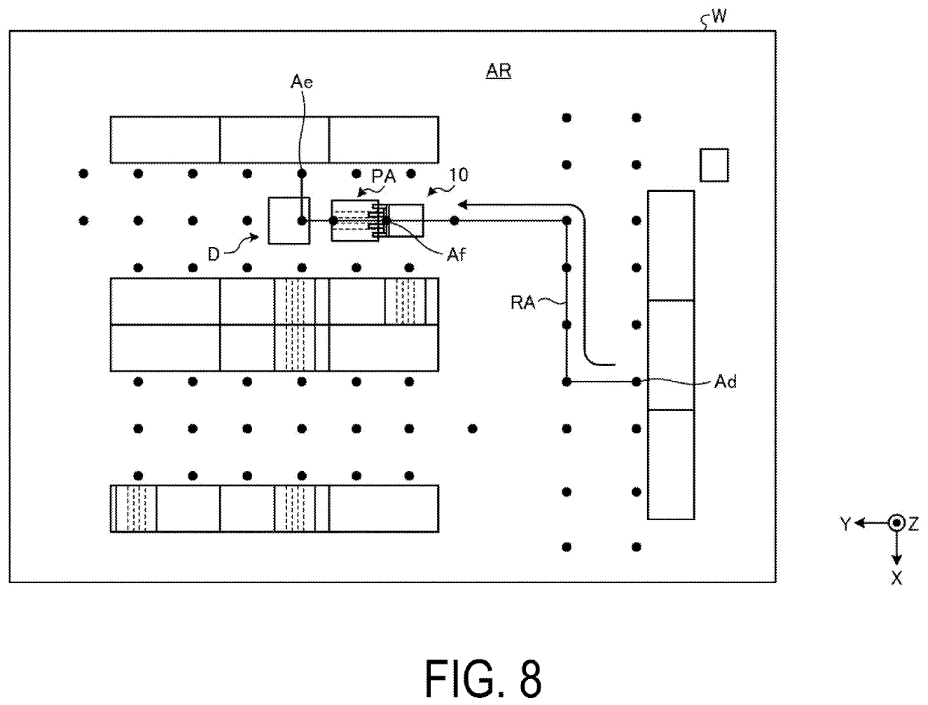

FIG. 8 is a schematic view illustrating processing to be performed when an obstacle is present. The mobile body 10 detects an obstacle present on the route R on the travel direction side of the mobile body 10 by using the obstacle detection unit 84. The obstacle detection unit 84 detects the surroundings of the mobile body 10, for example, by using the sensor 26A while the mobile body 10 is moving along the route R. The obstacle detection unit 84 finds out, as the obstacle information, that the obstacle has been detected on the route R on the travel direction side of the mobile body 10 as the obstacle information, by using the sensor 26A. Note that the presence of an obstacle on the route R on the travel direction side of the mobile body 10 is not limited to the situation in which the obstacle is definitely located on the route R, and also includes the presence of an obstacle within a predetermined distance range from the route R. It may be determined that an obstacle is present on the route R on the travel direction side of the mobile body 10 when the obstacle is present at a position where an interference will occur if the mobile body 10 continues to move along the route R. FIG. 8 illustrates an example in which the mobile body 10 conveying a target object PA is moving along a route RA from a waypoint Ad to a waypoint Ae (target position). That is, the route RA includes a route from the waypoint Ad that is the first position to the waypoint Ae that is the second position. FIG. 8 also illustrates an example in which an obstacle D is detected on the route RA.

When an obstacle is detected on the route R on the travel direction side, the movement control unit 82 of the mobile body 10 stops the mobile body 10, and determines whether or not it is possible to set an avoidance route that leads to the target position of the route R while avoiding the obstacle. In this case, for example, the obstacle detection unit 84 detects the position and the orientation of the obstacle by using the sensor 26A, and the movement control unit 82 tries to set the avoidance route that leads to the target position of the route R while avoiding the obstacle based on the position and the orientation of the obstacle. When it is possible to set the avoidance route, the movement control unit 82 switches to the avoidance route to continue the movement. On the other hand, when it is not possible to set the avoidance route, that is, for example, when it is not possible to set a route for moving ahead while avoiding the obstacle because a passage is narrow, the movement control unit 82 keeps stopping there. Then, the obstacle detection unit 84 transmits the obstacle information indicating that the obstacle has been detected on the route R on the travel direction side of the mobile body 10 to the information processing device 14, and an updated route is set by the information processing device 14. FIG. 8 illustrates a case where the mobile body 10 detects the obstacle D on the travel direction side at the waypoint Af and where it is not possible to set an avoidance route that leads to the waypoint Ae (target position) while avoiding the obstacle D.

In the present embodiment, when an obstacle is detected on the route R on the travel direction side of the mobile body 10, and when it is not possible to set an avoidance route, the obstacle information is transmitted to the information processing device 14 so as to set an updated route. However, it is not necessary to set the avoidance route, and when an obstacle is detected on the route R on the travel direction side of the mobile body 10, the obstacle information may be transmitted to the information processing device 14 so as to set an updated route without trying to set an avoidance route.

### Acquisition of Obstacle Information

The obstacle information acquisition unit 64 of the information processing device 14 acquires the obstacle information from the mobile body 10. In this case, the obstacle detection unit 84 of the mobile body 10 also sets, as the obstacle information, the position information of the obstacle in addition to the information indicating that the obstacle is present. Accordingly, the obstacle information acquisition unit 64 acquires the information indicating that the obstacle is present, and the position information of the obstacle as the obstacle information.

### Setting of Updated Route

Upon acquisition of the obstacle information, the work setting unit 62 of the information processing device 14 sets an updated route to an updated position as a new route of the mobile body 10 that has detected the obstacle. Specifically, the work setting unit 62 defines a nearby position located within a predetermined distance from the position of the obstacle based on the position information of the obstacle, and set the nearby position to be impassable. In other words, the work setting unit 62 reserves a waypoint A located within a predetermined distance from the position of the obstacle so that the mobile body 10 cannot reserve that waypoint A. The predetermined distance here may be set arbitrarily. The work setting unit 62 sets, as the updated route, a route that starts from the current position of the mobile body 10 (the position at which the obstacle is detected and the mobile body 10 is stopped) and reaches the updated position different from the target position of the original route R without passing through the nearby position. Note that the work setting unit 62 resets routes for other works scheduled after the timing at which the obstacle is detected so as not to pass through the nearby position.

The work setting unit 62 may set any position different from the target position of the original route R as the updated position. For example, the work setting unit 62 may set, as the updated position, a position on a side in a second direction opposite to a first direction with respect to the current position of the mobile body 10 (the position at which the obstacle is detected and the mobile body 10 is stopped), where the first direction heads from the current position to the obstacle. That is, in the example of FIG. 8, the direction heading from the waypoint Af (the current position of the mobile body 10) to the obstacle D is the Y direction, the work setting unit 62 may set a position on a side of the waypoint Af opposite to the Y direction as the updated position. That is, the work setting unit 62 may set the updated position such that the mobile body 10 moves back with respect to the obstacle.

Hereinafter, an example of setting an updated position and an updated route will be described.

### Example of Dropping Target Object at Updated Position

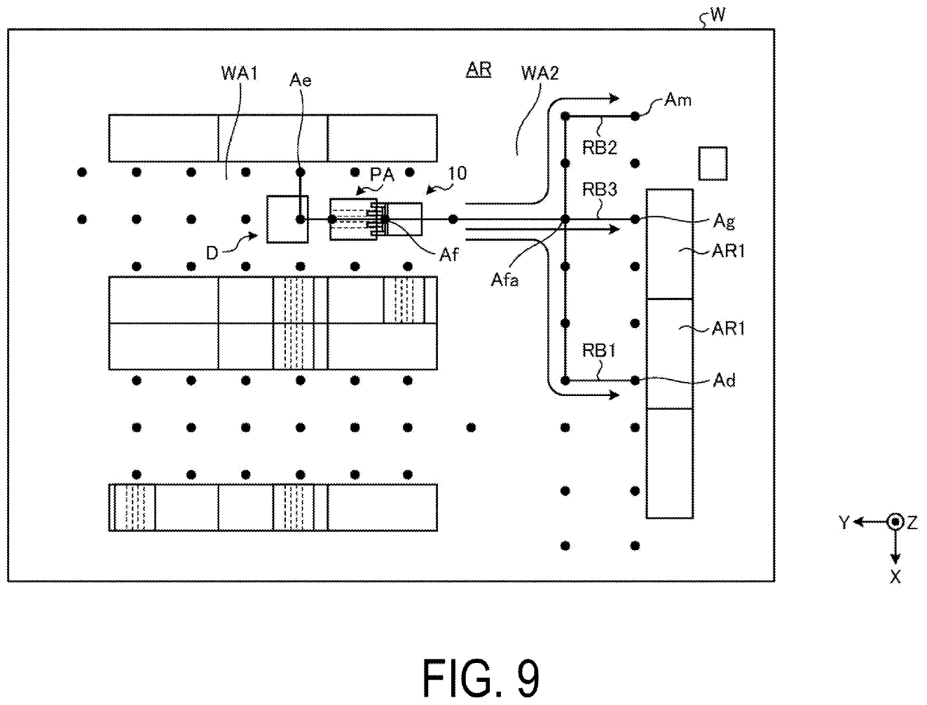

FIG. 9 is a schematic view illustrating an example of dropping a target object at an updated position. For example, the work setting unit 62 may set an updated route using a position different from the target position of the original route R as an updated position, while setting a command to drop the target object P being conveyed at the updated position. The work setting unit 62 transmits the set updated route and the command to drop at the updated position to the mobile body 10 that has detected the obstacle. The movement control unit 82 of the mobile body 10 causes the mobile body 10 to move along the updated route acquired, and upon arrival at the updated position, causes the mobile body 10 to drop the target object P being conveyed at the updated position. Subsequently, the mobile body 10 starts a subsequent work, and moves to the first position for the subsequent work.

The updated position in the case of dropping the target object at the updated position may be any position different from the target position. For example, the work setting unit 62 may set the first position (conveyance source) of the target object P being conveyed as the updated position. That is, in the example of FIG. 9, the work setting unit 62 may set the waypoint Ad that is the first position of the target object PA as the updated position. In that case, the mobile body 10 moves along the updated route RB1 from the waypoint Af to the waypoint Ad to return to the waypoint Ad, and drops the target object PA in the placement area AR1 facing the waypoint Ad. By returning the target object PA to the conveyance source in this manner, it is possible to continue a subsequent work without causing the target object PA to interfere with the movement of other mobile bodies 10.

In addition, for example, the work setting unit 62 may set, as the updated position, a waypoint A that does not overlap with a route connecting respective waypoints A facing respective placement areas AR1 (a route used for conveyance), such as a waypoint A that is a charging point or a waiting point. The updated route RB2 in FIG. 9 is an example in which the waypoint Am that is a standby position is set as the updated position. In this case, the mobile body 10 moves along the updated route RB2 from the waypoint Af to the waypoint Am and drops the target object PA at the waypoint Am. By temporarily placing the target object PA at the waypoint A that does not overlap with the route used for conveyance in this manner, it is possible to continue a subsequent work without causing the target object PA to interfere with the movement of other mobile bodies 10.

In addition, for example, the work setting unit 62 may set any waypoint A facing a placement area AR1 as the updated position. The updated route RB3 in FIG. 9 is an example in which the waypoint Ag facing a placement area AR1 is set as the updated position. In that case, the mobile body 10 moves along the updated route RB3 from the waypoint Af to the waypoint Ag, and drops the target object PA in the placement area AR1 facing the waypoint Ag. In this case, the work setting unit 62 sets, as the updated position, a waypoint A facing a placement area AR1 in which no other target objects P are placed. Thereafter, it is also preferable for the work setting unit 62 to set, as an updated position, a waypoint A facing a placement area AR1 in which no other target object P are planned to be placed. By temporarily placing the target object PA another placement area AR1, it is possible to continue a subsequent work without causing the target object PA to interfere with the movement of other mobile bodies 10.

In addition, for example, a direction heading from the current position of the mobile body 10 that has detected an obstacle to the obstacle is defined as a first direction. In this case, when a passage passing through a nearby position (a position at which the obstacle has been detected) intersects with another passage on a side in a second direction opposite to the first direction, the work setting unit 62 may set any position (waypoint A) between the current position of the mobile body 10 and the intersection with the another passage as the updated position. That is, in the example of FIG. 9, the passage WA1 passing through the position at which the obstacle D has been detected intersects the passage WA2 on the side in the second direction (opposite to the Y direction). In this case, the work setting unit 62 may set any position (waypoint A) between the waypoint Af, which is the current position, and the waypoint Afa, which is the intersection of the passage WA1 and the passage WA2, as the updated position. In this case, the mobile body 10 moves from the waypoint Af to the updated position between the waypoint Af and the waypoint Afa, drops the target object PA at the updated position, and moves to the first position for the next work. Here, the nearby position of the obstacle D is impassable, and thus it is assumed that other mobile bodies 10 do no pass through the passage WA1. Thus, by temporarily placing the target object PA between the current position and the intersection, it is possible to continue a subsequent work without causing the target object PA to interfere with the movement of other mobile bodies 10. Further, since the target object PA is temporarily placed at a position near the original target position, it is possible to quickly convey the target object PA to the target position after the obstacle is removed. Note that, since it is also assumed that another mobile body 10 enters the passage WA1 up to a near side of the nearby position of the obstacle D, the work setting unit 62 may set a position between the current position and the intersection as the updated position if there is no subsequent work passing through the passage WA1 (work passing through a waypoint A between the current position and the intersection).

Here, the obstacle on the route R may disappear from the route R, for example, by being removed. Upon acquisition of removal information indicating that the obstacle has disappeared from the route R, the obstacle information acquisition unit 64 of the information processing device 14 releases the impassable state of the nearby position of the obstacle and sets the nearby position to be passable. In other words, the work setting unit 62 cancels the reservation of a waypoint A located within a predetermined distance from the position of the obstacle. Then, upon acquisition of the removal information, the work setting unit 62 sets a reconveying route for conveying the target object P conveyed by the mobile body 10 that has detected the obstacle to the target position of the original route R. The reconveying route is a route from a position at which the target object P is dropped (temporarily placed) to the original target position. That is, in the above description, since the target object PA conveyed by the mobile body 10 is placed at the updated position, the work setting unit 62 sets, as the reconveying route, a route in which the updated position is the first position and the original target position of the target object PA (the waypoint Ae in the example of FIG. 9) is the second position. The work setting unit 62 may select any mobile body 10 as the mobile body 10 that conveys the target object PA along the reconveying route. For example, the work setting unit 62 may select the mobile body 10 that can complete the work of conveying the target object PA to the original target position in the shortest time as the mobile body 10 that reconveys the target object PA. In addition, the work setting unit 62 resets routes for other works scheduled after the timing at which the removal information is acquired such that the routes can pass through the nearby position.

Note that the obstacle information acquisition unit 64 may acquire the removal information in any manner. For example, when an operator removes the obstacle, the obstacle information acquisition unit 64 may acquire the removal information input by the operator. In this case, for example, the operator may input the removal information to a terminal held by the operator, or a computer installed in the facility W, and the obstacle information acquisition unit 64 may acquire the input removal information through communication.

### Example of Dropping Target Object at Current Position

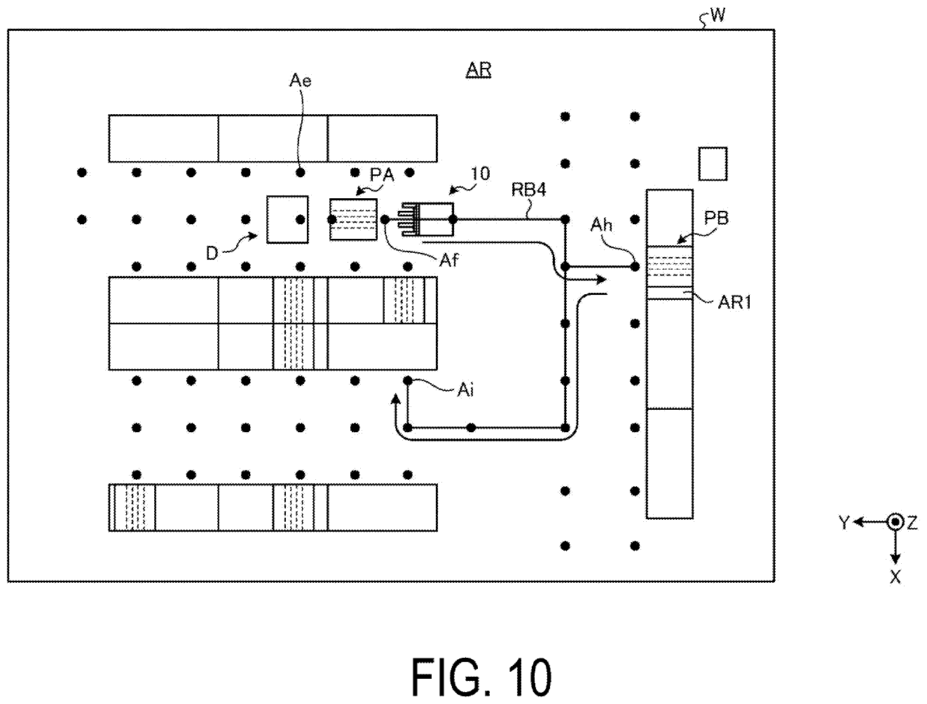

FIG. 10 is a schematic view illustrating an example of dropping a target object at a current position. The work setting unit 62 may set a command to drop the target object PA being conveyed at the current position of the mobile body 10, while setting an updated route in which a placement position (first position) of a target object P different from the target object PA being conveyed is set as the updated position. In that case, the work setting unit 62 sets the updated route from the current position of the mobile body 10 to the first position for a subsequent work of the mobile body 10, by using the first position for the subsequent work of the mobile body 10 as the updated position. The work setting unit 62 transmits the set updated route and the command to drop at the current position to the mobile body 10 that has detected the obstacle. The movement control unit 82 of the mobile body 10 causes the mobile body 10 to drop the target object PA at the current position, move along the updated route acquired, reach the first position for the subsequent work, and perform the subsequent work. In the example of FIG. 10, the mobile body 10 drops the target object PA at the waypoint Af that is the current position, and moves along the updated route RB4 from the waypoint Af to the waypoint Ah that is the first position for the subsequent work. Upon arrival at the waypoint Ah, the mobile body 10 picks up the target object PB located in the placement area AR1 facing to the waypoint Ah, and conveys the target object PB to the waypoint Ai that is the second position. Here, the nearby position of the obstacle D is impassable, and thus it is assumed that other mobile bodies 10 do not pass through the above-mentioned current position of the mobile body 10. Thus, by temporarily placing the target object PA at the above-mentioned current position of the mobile body 10, it is possible to continue a subsequent work without causing the target object PA to interfere with the movement of other mobile bodies 10. Further, since the target object PA is temporarily placed at a position near the original target position, it is possible to quickly convey the target object PA to the target position after the obstacle is removed.

Even in a case where the target object P is dropped at the current position, upon acquisition of the removal information, the work setting unit 62 sets a reconveying route for conveying the target object P dropped at the current position to the target position of the original route R. That is, in the above description, since the target object PA conveyed by the mobile body 10 is placed at the current position, the work setting unit 62 sets, as the reconveying route, a route in which the current position (the waypoint Af in the example of FIG. 10) is the first position and the original target position of the target object PA (the waypoint Ae in the example of FIG. 10) is the second position. The work setting unit 62 may select any mobile body 10 as the mobile body 10 that conveys the target object PA along the reconveying route. For example, the work setting unit 62 may select the mobile body 10 that can complete the work of conveying the target object PA to the original target position in the shortest time as the mobile body 10 that reconveys the target object PA.

### Selection of Updated Position

The work setting unit 62 may select (set) an updated position based on at least one of the size of the obstacle and the distance to a candidate position that is a candidate for the updated position. In that case, for example, the work setting unit 62 calculates the size of the obstacle based on the detection result of the obstacle by the sensor 26A. When the size of the obstacle is smaller than a predetermined size, the work setting unit 62 may set the first position for a subsequent work of the mobile body 10 as the updated position, and may cause the mobile body 10 to drop the target object P at the current position and then move to the updated position. In addition, for example, when the size of the obstacle is smaller than a predetermined size, the work setting unit 62 may set a position between the current position and the intersection as the updated position and may cause the target object P to be dropped at the updated position between the current position and the intersection. That is, when the obstacle is large in size, it is necessary to remove the obstacle by a maintenance vehicle, for example. In such a case, if the target object P is present at the current position or between the current position and the intersection, the removal operation is interrupted. Accordingly, it is preferable to temporarily place the target object P at such a position only when the size of the obstacle is smaller than a predetermined size.

In addition, for example, the work setting unit 62 may select a plurality of candidate positions that are candidates for the updated position, and may calculate the distance from the current position to each of the candidate positions. Then, the work setting unit 62 may set, from among the plurality of candidate positions, a candidate position having the shortest distance from the current position as the updated position. The candidate positions here may be included in the examples of the updated positions described above. By selecting the updated position in this manner, the target object P can be temporarily placed in a rapid manner.

In addition, for example, the work setting unit 62 may select an updated position based on both of the size of the obstacle and the distance to a candidate position. In that case, for example, when the size of the obstacle is smaller than a predetermined size, the work setting unit 62 sets either of the first position for a subsequent work of the mobile body 10 or a position between the current position and the intersection as the updated position. When the size of the obstacle is equal to or larger than a predetermined size, the work setting unit 62 may set, from among the candidate positions excluding the first position for a subsequent work of the mobile body 10 and a position between the current position and the intersection, a candidate position having the shortest distance from the current position as the updated position.

Note that, in the above description, an example has been described in which when an obstacle is present on the route R on the travel direction side of the mobile body 10 conveying the target object P, an updated route is set for the mobile body 10. However, the disclosure is not limited thereto, and an updated route for the mobile body 10 may be set in the same manner even when an obstacle is present on the route R on the travel direction side of the mobile body 10 that is moving without conveying the target object P. In that case, for example, the mobile body 10 may perform another work in which the first position for a subsequent work assigned to the mobile body 10 is set as the updated position and a route from the current position to the updated position is set as the updated route.

### Processing Flow

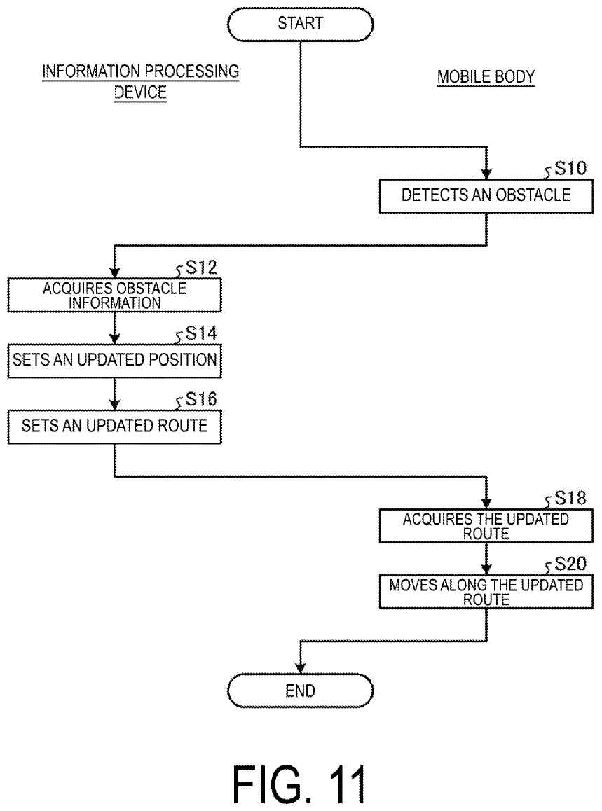

Processing flow for setting an updated route described above will be described with reference to a flowchart. FIG. 11 is a flowchart illustrating a flow for setting an updated route. As illustrated in FIG. 11, when an obstacle is detected on the route R on the travel direction side (step S10), the mobile body 10 transmits obstacle information to the information processing device 14. Upon acquisition of the obstacle information (step S12), the information processing device 14 sets an updated position (step S14), sets an updated route to the updated position (step S16), and transmits information on the updated route to the mobile body 10. Upon acquisition of the information on the updated route (step S18), the mobile body 10 moves along the updated route (step S20).

Note that, in the above description, the information processing device 14 sets the updated route. However, the subject that performs this processing is not limited to the information processing device 14. For example, when the mobile body 10 that has detected an obstacle acquires the obstacle information (when the mobile body 10 detects the obstacle), the mobile body 10 may set the updated route.

As described above, in the present embodiment, when the mobile body 10 detects the obstacle on the route R, the mobile body 10 sets the updated route to an updated position different from an original target position. Thus, the mobile body 10 can move along the updated route without being kept stopped in front of the obstacle, and the reduction in the operating ratio of the mobile body 10 can be suppressed. Further, in the present embodiment, since the target object P being conveyed is temporarily placed at an updated position or a current position, a subsequent work can be continued, and the reduction in the operating ratio of the mobile body 10 can be appropriately suppressed.

### Second Embodiment

Next, a second embodiment will be described. The second embodiment differs from the first embodiment in that, after a predetermined time has elapsed since an obstacle was detected, the mobile body 10 is caused to detect whether or not the obstacle is still present at the same position. In the second embodiment, the description of parts having the same configuration as those in the first embodiment will be omitted.

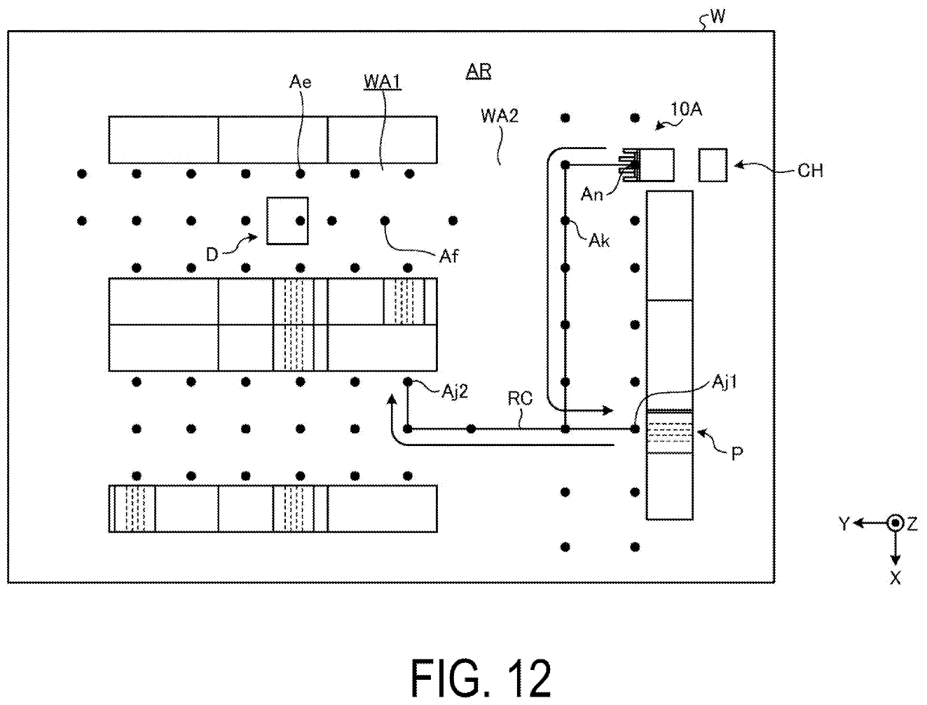

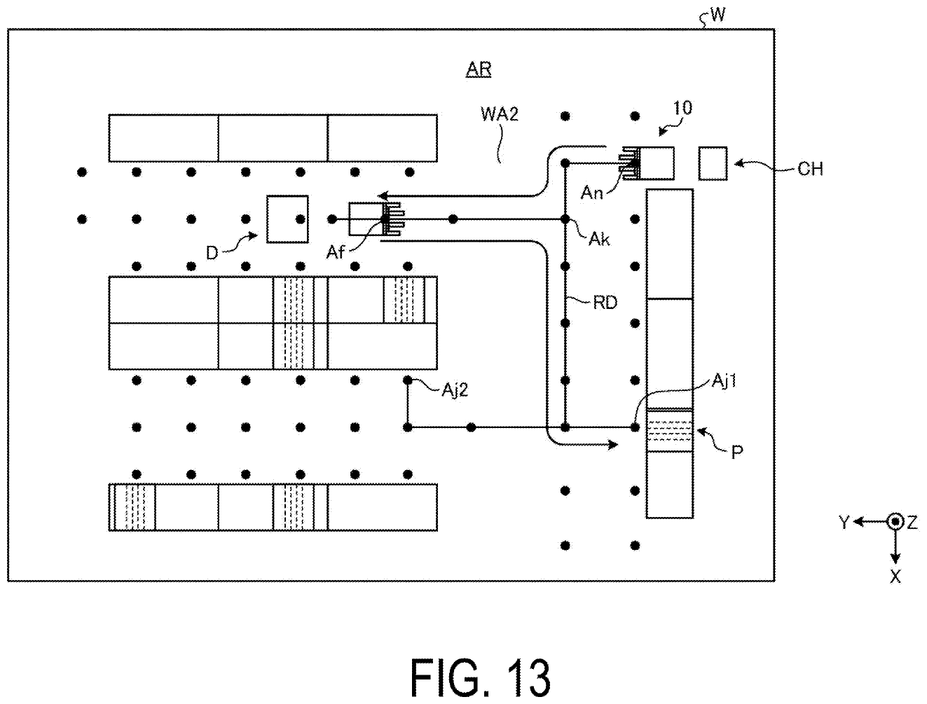

Each of FIGS. 12 and 13 is a schematic view illustrating an example of setting a detection route. In the second embodiment, the work setting unit 62 of the information processing device 14 sets a detection route when a predetermined time has elapsed since the acquisition of the obstacle information, that is, when a predetermined time has elapsed since an obstacle was detected on the route R. The detection route is a route passing through a detection position at which the obstacle can be detected. The detection position may be any position at which the obstacle can be detected, and may be, for example, a position (waypoint A) located within a predetermined distance range from the nearby position of the obstacle. The setting of the detection route will be described in detail below.

Here, the target position of the target object PA conveyed by the mobile body 10 that has detected the obstacle D (the waypoint Ae in the example of FIG. 12) is set as a first target position. In this case, after a predetermined time has elapsed since the acquisition of the obstacle information, if there is a work for which a route R leading to a second target position different from the first target position has been set, the work setting unit 62 sets, for a mobile body 10 to which the work is assigned, a route passing through the detection position and reaching the second target position as the detection route. Upon acquisition of the information on the detection route, the movement control unit 82 of the mobile body 10 causes the mobile body 10 to move along the detection route. When the mobile body 10 arrives at the detection position, the movement control unit 82 causes the sensor 26A to detect the surroundings (the position where the obstacle is present) to determine whether the obstacle is still present, and resumes the movement along the detection route toward the second target position. That is, the mobile body 10 stops at the detection position to detect the obstacle D before heading to the second target position. When it is determined that the obstacle is no longer present, the movement control unit 82 transmits the removal information to the information processing device 14. Since the processing after the information processing device 14 acquires the removal information is the same as that in the first embodiment, description thereof is omitted. On the other hand, when it is determined that the obstacle is still present, the movement control unit 82 may or need not transmit the information indicating that the obstacle is remaining to the information processing device 14. When the obstacle is remaining, that is, when the removal information has not been acquired, or when the information indicating that the obstacle is remaining has been acquired, the information processing device 14 may repeat the same processing for setting a detection route after a predetermined time has elapsed.

In addition, when a position located within a predetermined distance from the position at which the obstacle was detected (or a detection position) is set as a via-point, and if there is a work for which a route R passing through the via-point and reaching a second target position has been set, the work setting unit 62 sets a detection route for a mobile body 10 to which the work is assigned. That is, the work setting unit 62 causes the mobile body 10 that is scheduled to pass through a position near the obstacle D to stop at the detection position and detect the obstacle D. This makes it possible to suppress an increase in time for detecting the obstacle D. Note that the via-point may be any position located within a predetermined distance from the position at which the obstacle was detected (or a detection position), and may be, for example, the intersection of the passage WA1 and the passage WA2 (the waypoint Ak in the example of FIG. 12).

In the example of FIG. 12, the detection position is the waypoint Af, and the via-point is the waypoint Ak. Also, in the example of FIG. 12, after a predetermined time has elapsed since the obstacle D was detected, a route RC from the waypoint An that is the initial position, through the waypoint Aj1 that is the first position, to the waypoint Aj2 that is the second position is set for the mobile body 10A. The route RC passes through the waypoint Ak, which is the via-point, in the course of moving from the initial position to the first position. That is, since the route RC of the mobile body 10A passes through the waypoint Ak (via-point) in the course of moving from the waypoint An (initial position) to the waypoint Aj1 (first position), the information processing device 14 sets a detection route for the mobile body 10A. Specifically, as illustrated in FIG. 13, the information processing device 14 sets, as a detection route RD, a route leading from the waypoint An (initial position), through the waypoint Af (detection position), to the waypoint Aj1 (first position) and reaching the waypoint Aj2 (second position). The mobile body 10A detects, at the waypoint Af, whether the obstacle D is present, moves to the waypoint Aj1 to pick up the target object P, and then moves to the waypoint Aj2 to drop the target object P.

Note that, in the examples of FIGS. 12 and 13, a detection route is set for the mobile body 10A when a route passing through a via-point between the initial position (departing position) and the first position (conveyance source) has been set, but the disclosure is not limited thereto. For example, even when a route passing through a via-point between the first position (conveyance source) and the second position (conveyance destination) has been set, a detection route may be set to the mobile body 10 for which the route has been set. In that case, the information processing device 14 sets a route leading from the initial position to the first position, from the first position to the detection position, and then from the detection position to the second position as a detection route.

Here, the removal information indicating that the obstacle has been removed may be input by an operator. However, in the case where the removal information is input by the operator, there is a concern that the removal information is erroneously input even though the obstacle has not been removed, or the input of the removal information is omitted even though the obstacle has been removed. In contrast, in the second embodiment, the mobile body 10 performing a work is caused to swing by a detection position so as to detect whether the obstacle is still present. Accordingly, it is possible to prevent the erroneous input or the omission of the input of the removal information and appropriately detect the information indicating that the obstacle has been removed. This makes it possible to appropriately set a route for the mobile body 10 in accordance with the presence or absence of the obstacle, and consequently suppress the reduction in the operating ratio of the mobile body 10.

Note that the processing in the second embodiment may be performed alone without being combined with the processing in the first embodiment. That is, when an obstacle is detected, a detection route toward a detection position of the obstacle may be set as in the second embodiment without setting an updated route. In addition, in the above description, a detection route is set by the information processing device 14, but the disclosure is not limited thereto, and the mobile body 10 may set a detection route by itself.

### Effects of the Disclosure

As described above, the information processing method according to the disclosure includes a step of acquiring obstacle information from a mobile body 10 moving along a route R to a target position, the obstacle information indicating that an obstacle is present on the route R, and a step of setting an updated route leading to an updated position that is a position different from the target position as a route for the mobile body 10 upon receipt of the obstacle information. According to the disclosure, the mobile body 10 can move along the updated route without being kept stopped in front of the obstacle, and the reduction in the operating ratio of the mobile body 10 can be suppressed.

The information processing method according to the disclosure further includes a step of causing the mobile body 10 to move along the updated route. According to the disclosure, the mobile body 10 can move along the updated route without being kept stopped in front of the obstacle, and the reduction in the operating ratio of the mobile body 10 can be suppressed.

In the step of setting an updated route, a position on a side in a second direction opposite to a first direction with respect to the current position of the mobile body 10 is set as the updated position, the first direction heading from the current position to the obstacle. By setting the updated position in this manner, backward movement with respect to the obstacle becomes possible, and a subsequent work can be appropriately performed.

In the step of setting an updated route, the updated position is set based on at least one of the size of the obstacle and the distance to a candidate position that is a candidate for the updated position. By setting the updated position in this manner, a subsequent work can be appropriately performed.

In the disclosure, the mobile body 10 is conveying a target object P, and in the step of setting an updated route, a command to drop a target object PA being conveyed at the current position of the mobile body 10 is set, while the updated route is set in which a placement position (first position) of a target object P different from the target object PA being conveyed is set as the updated position. According to the disclosure, since the mobile body 10 is caused to drop the target object P at the current position and then move to the first position for a subsequent work, the subsequent work can be continued, and the reduction in the operating ratio of the mobile body 10 can be appropriately suppressed.

In the disclosure, the mobile body 10 is conveying a target object P, and in the step of setting an updated route, the updated route is set using a position different from the target position as the updated position, while a command to drop the target object P being conveyed at the updated position is set. According to the disclosure, since the target object P is dropped at the updated position, a subsequent work can be continued, and the reduction in the operating ratio of the mobile body 10 can be appropriately suppressed.

In the disclosure, further included are a step of acquiring removal information indicating that the obstacle has disappeared from the route R, and a step of setting a reconveying route that is a route from a position at which the target object PA is dropped to the target position upon acquisition of the removal information. According to the disclosure, the target object PA temporarily placed can be appropriately conveyed to the original target position after the obstacle disappears.

The information processing method according to the disclosure includes a step of acquiring obstacle information from a mobile body 10 moving along a route to a first target position, the obstacle information indicating that an obstacle is present on the route, and a step of setting a detection route for a mobile body 10 for which a route to a second target position different from the first target position is set, the detection route being a route passing through a detection position at which the obstacle can be detected and reaching the second target position. According to the disclosure, the mobile body 10 performing a work is caused to swing by the detection position so as to detect whether the obstacle is still present. Accordingly, it is possible to prevent the erroneous input or the omission of the input of the removal information and appropriately detect the information indicating that the obstacle has been removed. Thus, the reduction in the operating ratio of the mobile body 10 can be suppressed.

In the step of setting a detection route, when a route to the second target position passes through a via-point located within a predetermined distance from a position at which the obstacle is detected, the detection route is set for a mobile body 10 for which the route has been set. By causing the mobile body 10 that is scheduled to pass through a position near the obstacle to stop at the detection position and detect the obstacle in this manner, the increase in time for detecting the obstacle can be suppressed.

The embodiments of the disclosure have been described above, but the embodiment is not limited by the details of the embodiments above. Furthermore, the constituent elements of the above-described embodiments include elements that are able to be easily conceived by a person skilled in the art, and elements that are substantially the same, that is, elements of an equivalent scope. Furthermore, the constituent elements described above can be appropriately combined. Furthermore, it is possible to make various omissions, substitutions, and changes to the constituent elements within a range not departing from the scope of the above-described embodiments.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. An information processing method comprising:
acquiring obstacle information from a mobile body moving along a route to a target position, the obstacle information indicating that an obstacle is present on the route; and
setting an updated route leading to an updated position as a route for the mobile body upon receipt of the obstacle information, the updated position being a position different from the target position.

2. The information processing method according to claim 1, further comprising causing the mobile body to move along the updated route.

3. The information processing method according to claim 1, wherein, in the setting an updated route, a position on a side in a second direction opposite to a first direction with respect to a current position of the mobile body is set as the updated position, the first direction heading from the current position to the obstacle.

4. The information processing method according to claim 1, wherein, in the setting an updated route, the updated position is set based on at least one of a size of the obstacle and a distance to a candidate position that is a candidate for the updated position.

5. The information processing method according to claim 1, wherein
the mobile body is conveying a target object, and
in the setting an updated route, a command to drop the target object being conveyed at a current position of the mobile body is set, while the updated route is set such that a placement position of another target object different from the target object being conveyed is set as the updated position.

6. The information processing method according to claim 1, wherein
the mobile body is conveying a target object, and
in the setting an updated route, the updated route is set such that a position different from the target position is set as the updated position, while a command to drop the target object being conveyed at the updated position is set.

7. The information processing method according to claim 1, further comprising
acquiring information indicating that the obstacle has disappeared from the route, and
setting a reconveying route upon acquisition of the information indicating that the obstacle has disappeared, the reconveying route being a route from a position at which a target object is dropped to the target position,
wherein the mobile body is conveying the target object.

8. An information processing method comprising:
acquiring obstacle information from a mobile body moving along a route to a first target position, the obstacle information indicating that an obstacle is present on the route; and
setting a detection route for a mobile body for which a route to a second target position different from the first target position has been set, the detection route being a route passing through a detection position at which the obstacle can be detected and reaching the second target position.

9. The information processing method according to claim 8, wherein, in the setting a detection route, when the route to the second target position passes through a via-point located within a predetermined distance from a position at which the obstacle is detected, the detection route is set for a mobile body for which the route to the second target position passing through the via-point has been set.

10. An information processing device comprising:
an obstacle information acquisition unit configured to acquire obstacle information through a mobile body moving along a route to a target position, the obstacle information indicating that an obstacle is present on the route; and
a work setting unit configured to set an updated route to an updated position as a route for the mobile body upon receipt of the obstacle information, the updated position being a position different from the target position.

11. A non-transitory computer readable storage medium storing a program for causing a computer to perform processing, the processing comprising:
acquiring obstacle information through a mobile body moving along a route to a target position, the obstacle information indicating that an obstacle is present on the route; and
setting an updated route to an updated position as a route for the mobile body upon receipt of the obstacle information, the updated position being a position different from the target position.
